(19) United States
(12) Patent Application Publication
(10) Pub. No.: US 2011/0126132 A1
(43) Pub. Date: May 26, 2011

(54) SYSTEM AND METHODS OF GENERATING SOCIAL NETWORKS IN VIRTUAL SPACE

(76) Inventors: Tyler Robert Anderson, Scottsdale, AZ (US); Scott Anthony Menor, Tempe, AZ (US); Michael Gregory Witham, Scottsdale, AZ (US)

(21) Appl. No.: 12/947,752

(22) Filed: Nov. 16, 2010

Related U.S. Application Data
(60) Provisional application No. 61/262,997, filed on Nov. 20, 2009.

(51) Int. Cl. G06F 15/16; G06F 3/01

(52) U.S. Cl. 715/758; 709/228; 709/227; 715/753

(57) ABSTRACT

A system and method of generating social networks within a virtual space, wherein the virtual space may be defined by the geographic location of the user or a metric based on a user attribute. The present invention permits a user to establish the outermost geographic boundaries of a virtual space, in which the user may establish a communication link for the purposes of social networking. The present invention allows for fixed and user-defined virtual space in which both permanent and terminable social networks may be created. Permanent virtual spaces provide the convenience of archiving and searchable review. The present invention allows for a user to be assigned to an existing virtual space based on a metric, or for a new virtual space to be created for a user based on a metric.

### CROSS REFERENCE TO RELATED APPLICATIONS

This application claims the benefit of provisional U.S. patent application 61/262,997, dated 20 Nov. 2009, herein incorporated by reference.

### BACKGROUND

1. Field of the Invention

The present invention relates generally to social networks in virtual spaces, wherein the virtual spaces are defined in part on geographic location, or defined in part by other metrics. In particular, the present invention relates to a system and methodology to provide social network service on electronic communication devices in a virtual space, wherein the user defines the virtual space relative to the user's geographic location, or the virtual space is defined in part based on a metric.

2. Description of the Related Art

The Internet has revolutionized social interactions through widespread accessibility. In particular, social-networking sites, such as FACEBOOK™, MYSPACE™, and TWITTER™, connect billions of users daily by interest, relationship, geography, or the like. The ways in which social-networking services are provided is endless, including but not limited to blogging, micro-blogging, online-chat, video conferencing, content sharing, and any other types of social networking services.

Essentially, social-networking services facilitate interactions by being at least partially anonymous, widely accessible, efficient, and devoid of geographical hindrances. One such example is online dating, where users enroll in a service, create a profile, and either view the profiles of others or allow the service to arrange a match. The process saves time and provides a refuge from those eschewing an awkward in-person method. Another example is online chat rooms, where users communicate in real-time through asynchronous or synchronous messaging on internet sites. The process allows a medium for users of similar interest, age, demographic, or dissimilar characteristics to communicate efficiently.

The industrial landscape has been revolutionized by social-networking services as well. Business video chat, such as WEBEX™, GOTO MEETING™, and SKYPE™ connect persons and information in real-time around the globe. Global availability and accessibility to communication and information platforms have enabled business to lower costs and connect with greater ease. Further, given the advances in network infrastructures, persons and companies have real-time access to documents both remotely or wirelessly, which facilitates productivity.

Social-networking sites generate revenue in a variety of ways, including charging for storage, paying for popularity, charging for advertisement space, or charging for software. However, various sites, such as the GOOGLE.COM™, YELP™, or BING.COM™, rely on selling focused advertising data and allowing sponsorship of links. These sites mine data about the user and provide targeted advertising data to interested parties. The process allows for greater yield per advertisement dollar.

As the capacity of mobile communication devices increase, along with the bandwidth available to mobile users, device manufacturers will continue to increase the complexity of operations on mobile communication devices. Furthermore, as demonstrated by the iPhone Application System, user-defined or user programmed applications have allowed virtually limitless applications for customizing the operation of mobile communication devices.

Furthermore, the proliferation of global positioning systems, including Global Navigation Satellite System (GNSS), cell-tower triangulation, or other methods of ascertaining location in real-time incorporate another degree of operability to mobile communication devices.

So as to reduce the complexity and length of the Detailed Specification, and to fully establish the state of the art in certain areas of technology, Applicants herein expressly incorporate by reference all of the following materials identified in each numbered paragraph below.
Pepe et al., U.S. Pat. No. 5,742,668, Issued Apr. 21, 1998
Pepe et al., U.S. Pat. No. 5,742,905, Issued Apr. 21, 1998
Schindler, U.S. Pat. No. 6,081,830, Issued Jun. 27, 2000
Naidoo, U.S. Pat. No. 6,629,136, Issued Sep. 30, 2003
Friedman, U.S. Pat. No. 6,714,791, Issued Mar. 30, 2004
Domnitz, U.S. Pat. No. 6,912,398, Issued Jun. 28, 2005
Martin, U.S. Pat. No. 6,931,114, Issued Aug. 16, 2005
De Vries, U.S. Pat. No. 6,968,179, Issued Nov. 22, 2005
Hose et al., U.S. Pat. No. 7,133,685, Issued Nov. 7, 2006
Liebman et al., U.S. Pat. No. 7,359,894, Issued Apr. 15, 2008
Crowley et al., U.S. Pat. No. 7,593,740, Issued Sep. 22, 2009
Moriss, US 2002/0174248, Pub. Nov. 21, 2002
Balani, US 2003/0007464, Pub. Jan. 9, 2003
Chaudhuri, US 2005/0038876, Pub. Feb. 17, 2005
Rosen, US 2006/0161599, Pub. Jul. 20, 2006
Phillips et al., US 2007/0244633, Pub. Oct. 18, 2007
Anupam et al. US 2007/0270163, Pub. Nov. 22, 2007
Hampel et al. US 2007/0270161, Pub. Nov. 22, 2007
Poosala, US 2007/0270132, Pub. Nov. 22, 2007
Altman et al., US 2007/0281716, Pub. Dec. 6, 2007
Krumm et al., US 2008/0032703, Pub. Feb. 7, 2008
Agarwal et al., US 2008/0040437, Pub. Feb. 14, 2008
Fisher, US 2009/0215469, Pub. Aug. 27, 2009

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), applicant(s) will amend the specification to expressly recite the essential material that is incorporated by reference as allowed by the applicable rules.

### OBJECTIVES OF THE INVENTION

It is an objective of the invention to allow users to communicate with others in their geographic area.

It is another objective of the invention to allow users to receive information related to their geographic area.

It is another objective of the invention to allow users to remotely communicate with others in a geographic area, while outside of that geographic area.

It is another objective of the invention to create a user defined social network.

It is another objective of the invention to facilitate communication in a user defined searchable social network.

It is another objective of the invention to establish a social network in a virtual space on a mobile device.

It is another objective of the invention to provide information to users that is supplied by businesses or other entities.

It is another objective of the invention to sort or categorize users based on their interaction or other characteristics.

The above and other objectives may be achieved using devices involving an internet-ready mobile device, such as a cell phone, laptop, PDA, GPS or other navigational assistance unit, media player, etc. capable of showing a map that lets users pinpoint a location in which they wish to communicate with others, and then connect and chat with others in that area.

The above and other objectives may be achieved using methods involving a user's mobile device or other internet-ready device recognizing its location, either via GPS, cell triangulation, or other technique, and the user creating a boundary surrounding their position as shown on a map on their device, thereby setting up a chat room, or other social network, accessible to people actually within that boundary, and allowing them to communicate with one another.

The above and other objectives may be achieved using methods involving a user, on their internet-ready device, mobile or otherwise, searching for chat rooms, or other social networks, that have been created by users who have limited the accessibility to the rooms to a geographic area they defined on a map on their respective device, the device displaying a list of rooms the user, which they may choose to enter in order to communicate with other users.

The above and other objectives may be achieved using methods involving creating a user-defined social network comprising a user defining a geographic area by establishing an outermost geographic boundary relative to the user's current location on a map displayed on the user's mobile device, creating a virtual space that facilitates communication among users based on the outermost geographic boundary established by the user, and establishing a communication link.

Some aspects of the invention may include a user defining a topic of the virtual space.

Some aspects of the invention may include a user defining accessibility of the virtual space.

Some aspects of the invention may include a user defining at least one searchable parameter of the virtual space.

Some aspects of the invention may include detecting user entry and departure of the virtual space.

Some aspects of the invention may include archiving communication within the virtual space.

Some aspects of the invention may include detecting departure of all users and terminating access to the virtual space.

Some aspects of the invention may include the social network being a chat room.

Some aspects of the invention may include creating an advertisement space within the virtual space.

The above and other objectives may be achieved using methods involving communicating in a user defined searchable social network comprising, querying available virtual spaces based on a user's geographic location, where the user's access to the virtual spaces is determined by previously defined geographic boundaries, generating a list of available virtual spaces accessible to the user, selecting at least one virtual space from the list of available virtual spaces, establishing a communication link between the at least one virtual space and the user.

Some aspects of the invention may include querying available virtual spaces based on a predetermined location.

Some aspects of the invention may include querying available virtual spaces based on topic.

Some aspects of the invention may include communicating in a chat room within the virtual space.

Some aspects of the invention may include archiving communications within the virtual space.

Some aspects of the invention may include the communication link established providing an accessibility permission to first a user that is different from an accessibility permission provided to a second user.

The above and other objectives may be achieved using devices involving a system that establishes a social network in a virtual space on a mobile device comprising, a display having an interactive map that is configured to allow a user to define geographic boundaries within which the user must be located, the geographic boundaries defining a zone of accessibility, within which one or more users must be located to access the virtual space, and a user interface configured to allow the one or more users to communicate within the virtual space, and where the mobile device is configured to communicate wirelessly.

Some aspects of the invention may include the virtual space being a chat room.

Some aspects of the invention may include the user defining a topic of the virtual space.

Some aspects of the invention may include a user defining at least one searchable parameter of the virtual space.

Some aspects of the invention may include a user defining the accessibility of the virtual space.

Some aspects of the invention may include devices further configured to archive communication within the virtual space.

Some aspects of the invention may include the user interface being further configured to detect departure of all users and terminate user access to the virtual space.

Some aspects of the invention may include the display being further configured to display advertisement space within the virtual space.

The above and other objectives may be achieved using methods involving creating a social network, such as a chat room, relative to the location where a user connected to the network.

The above and other objectives may be achieved using methods involving a user being placed in an existing social network, such as a chat room, based on the geographic location from which the user connected to the network.

The above and other objectives may be achieved using methods involving a user being placed in an existing social network, such as a chat room, based on information gleaned from the user's profile or logon information.

The above and other objectives may also be achieved using methods involving a user being placed in an existing social network, such as a chat room, based on the user's past communication, if any, in a social network created by the present invention.

The above and other objectives may be achieved using methods involving a user being placed in an existing social network based on one of the above metrics, any combination of the above metrics, or any other possible metric.

Some aspects of the invention may include a user defining a topic of the virtual space.

Some aspects of the invention may include a user defining accessibility of the virtual space.

Some aspects of the invention may include a user defining at least one searchable parameter of the virtual space.

Some aspects of the invention may include detecting user entry and departure of the virtual space.

Some aspects of the invention may include archiving communication within the virtual space.

Some aspects of the invention may include detecting departure of all users and terminating access to the virtual space.

### SUMMARY OF THE INVENTION

The invention includes a social-networking service that provides a platform for connecting people by desired location or topic in a virtual space. The platform allows for a variety of social-networking services to be used within the virtual space. Further, the platform has the capability to store and archive communication within a virtual space by any number of parameters, including location, topic, date, time, or name.

The invention includes a collection of open communication spaces, or virtual spaces. A virtual space may be created by a user based on the user's location or created based on a metric based on a user attribute. In addition, a virtual space may be fixed without regard to user location or preferences. Further, the virtual space may be categorized by a number of parameters, including predefined or user-defined locations, topics, date, time, or names. Each virtual space has the capacity to provide similar or dissimilar social networking services. In addition to real-time interaction and communication, the virtual spaces may have the capacity to store all or some of the communication activity that occurs within the space, within any number of storage devices, such as virtual or server archives. The invention may act as both a tool for real-time interaction, as well as a method of archiving interactions within that space for subsequent review or storage.

The invention may include formation, creation, or dissolution of a virtual space. A user may search for information, datum, and communication that have taken place within the social-networking service of a predefined virtual space. A user may review archived data from a virtual space if the data archived takes place in a fixed open virtual space. In another embodiment of the invention, a user-defined virtual space may be open as long as user activity is detected in the space. The social-networking service may detect limited or no user activity and cease archiving activity. In addition, the social-networking service may document limited or no user activity and archive the events.

In some applications of the invention, virtual spaces may be predefined by location or topic based on a variety of factors including popularity, presence of business interests, commonality, user request or user suggestion. A user may be placed into one or more of these predefined virtual spaces based on a metric generated by a user attribute. For example, the attribute can be, but is not limited to, the user's location, past user activity, and/or the user's logon or profile information.

In one implementation of an infrastructure, a virtual space corresponding to a physical location may be created according to a directory, such as YELP.COM™.

In some applications of the invention, the virtual space may be a user-defined virtual space where social-networking services are inserted and customizable by a variety of methods, including labeling the space by existing physical locales. Virtual spaces not pre-defined and permanent, along with its associated social-networking services may remain in existence until all or most of the communication has ceased. Those virtual spaces may automatically vanish from the library of available virtual spaces. A virtual space user-defined by topic or a pre-defined location may be permanent and contain no location reference to a specific user. Further, a permanent virtual space may consistently be available in a library of available virtual spaces. Further, a permanent virtual space may involve real-time and permanent archiving of all datum, communication, and information that is or is not exchanged or offered by a user within the virtual space.

A user may access the virtual spaces through a variety of devices, including computers or handheld mobile communication devices. Computer interaction with the virtual spaces may be consolidated at a particular site, which grants full range and access to the virtual spaces and associated social-networking services. Users may search the entire library for specific virtual spaces related to desired keywords, current location, special topic(s), popularity, or random. Users may not be limited in ability to join and interact among multiple virtual spaces simultaneously. In addition to search, users can navigate virtual spaces with the aid of buddy lists, users, favorites, topic or direct URL destination. Once logged into a virtual space, users may see, join, or be alerted to enter the virtual space based on a buddy list. In one embodiment, a user-defined topic such as, for example, “Phoenix Suns,” may be directly reachable at a specified site or permanent location at a specified site.

A permanent or lasting virtual space may be assigned a unique label. On the other hand, a temporary or non-permanent virtual space may not use labels or a specified permanent location at a specified site. The platform for creation of the virtual space or associated social-networking platform associated therewith may be scaled to a plurality of versions for proper application to any number of devices.

A virtual space may be programmed to syndicate content, such as information, data, or signals, to or for third-party sites and services automatically. Some aspects of the invention may include automatically feeding or syndicating information posted on a third-party website or service that relates to a permanent virtual space to that virtual space. Any syndicated content interaction may then be syndicated back to original syndic. One example may include a first user posting a micro-blog at Scottsdale Fashion Square Mall, the micro-blog syndicates automatically to a permanent virtual space over Scottsdale Fashion Square Mall. Next, a second user may respond to a syndicated micro-blog in the virtual space, whereby the response is syndicated back to the first user's micro-blog page.

A virtual space is customizable to include a variety of markup languages, including HTML, SGML, XML, and others, that enable users to freely embed, syndicate, broadcast, or transmit data, information, or content with other sites in the virtual space or vice versa.

A virtual space may operate on a virtual timeline that allows interaction with information present, past and future. In addition to real-time interaction, a virtual space may allow users to post media, information, or data at prescribed times. Users of an archived virtual space may have the ability to interact with or view archived communications, data, media, or other information.

In one aspect of the invention, a virtual space may be organized without a formal set of rules or guidelines. The rules or guidelines may be established by an elected, selected, or randomly assigned administrator. The administrator may organize the virtual space to operate under any rules in which the administrator deems necessary for the virtual space. Administrator control may be limited by term and may be governed by overriding rules for all virtual space.

Another aspect of the invention is that a virtual space may be organized to place each user into a specific group based on the user's personality. The group may be associated by a variety of factors including profiles containing personality, interests, psychological profile, age, ethnicity, gender, sexual orientation, interests or many others. In addition, a virtual space may automatically gather information or store information on users in a virtual trail. The profile information on users may help establish a proper grouping or facilitate election as an administrator. For example, a user may logon using his or her Facebook® account, and the invention may gather information about the user from his or her Facebook® profile.

A virtual space may provide video, audio or informational tutorials to aid users in manipulating the full operability of the space and any associated social networking programs. The tutorial space may also be available for plug-in or external software implementations into the virtual space.

The virtual space may allow a user to select, track or subscribe to favorite spaces, topics or specific social networking destinations (e.g., a certain user's chat room, a certain user's twitter micro-blog, or a professor's blackboard discussion). The virtual space and accompanying social networking services may enable a user to tail a substantially unlimited number of virtual spaces, accessible through a user-friendly homepage or other method. The tails may be sorted, arranged, further categorized or ranked, among other things.

The virtual space may have the ability to individually track user activity. In such an instance, users may have the option to set the privacy or encrypt that which is available to the public or archived. A virtual space may have the ability to act as a personal time capsule. The user may decide which media may be seen.

In one aspect of the invention, a virtual space may be organized based on a metric based on various user attributes, such as, but not limited to, a user's logon and profile information, a user's location, and a user's past communications within the virtual space. The user is placed in a chat room or other social network based on a metric derived from these user attributes. This chat room or other social network may be created for the user or may be a pre-existing chat room or other social network that the user is placed into based on the metric.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. §112, ¶ 6. Thus, the use of the words “function,” “means” or “step” in the Detailed Description or Description of the Drawings or claims is not intended to somehow indicate a desire to invoke the special provisions of 35 U.S.C. §112, ¶ 6, to define the invention. To the contrary, if the provisions of 35 U.S.C. §112, ¶ 6 are sought to be invoked to define the inventions, the claims will specifically and expressly state the exact phrases “means for” or “step for,” and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. §112, ¶ 6. Moreover, even if the provisions of 35 U.S.C. §112, ¶ 6 are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE DRAWINGS

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

FIG. 1 shows a view of a chat room home screen on a device, in accordance with some of the embodiments of the invention.

FIG. 2 shows a view of a virtual chat room on a device, in accordance with some of the embodiments of the invention.

FIG. 3 shows an example flow chart of creating social network based on geographic location on a device, in accordance with some of the embodiments of the invention.

FIG. 4 shows an example flow chart of creating social network based on geographic location or topic on a device, in accordance with some of the embodiments of the invention.

FIG. 5 shows an example flow chart of creating a social network based on a metric generated from various user attributes, in accordance with some of the embodiments of the invention.

### DETAILED DESCRIPTION OF THE INVENTION

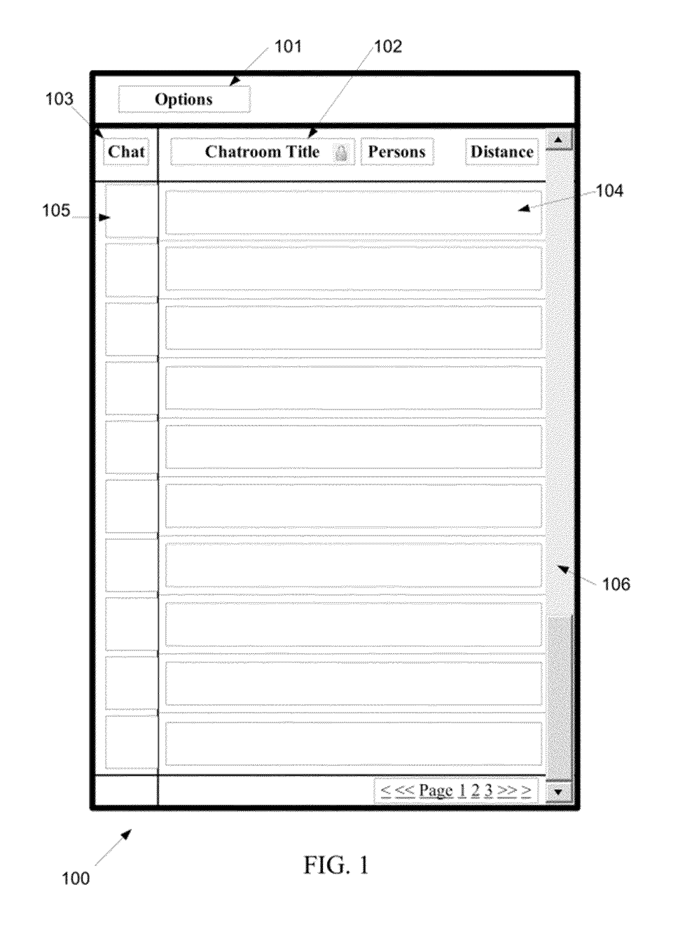

FIG. 1 illustrates a social network service home screen system (“system”) 100 on a mobile device operating in a virtual space. A mobile device may include, but is not limited to, a laptop, netbook, mobile phone, music player, or personal data assistant. The system 100 includes control options 101 that allow the user to operate the system. System 100 includes a plurality of tools for controlling and querying the social network services. System 100 includes a plurality of tools for sorting, arranging, identifying, viewing, and reviewing information and data within the social network services of a virtual space.

In some implementations, a chat room is created in a virtual space, displaying a system 100 on a mobile device. The chat room may be controlled by a user through various control options 101. The control options 101 may allow a user to create, select, or search for an available chat room. The control options 101 may also allow a user to query available chat rooms based on a plurality of search parameters, including chat room feed distance, topic, or location. The system 100 contains a plurality of methods for navigating, sorting, and ordering the results of a query for available chat rooms. The navigating options 102 may include various ways and terms for sorting and ordering, as shown by chat room order 103. For example, navigating options 102 allow a user to partially view navigational panels 104. The chat room navigational panels 104 may be sorted by privacy options, accessibility, feed location, geographic location, events and which user created the chat room. The chat room navigational panels 104 may be sorted, using navigating options 102, by chat room title, topic, popularity, distance, location, and availability. The chat room may include various ways of browsing navigational panels 104, for content including, scroll bar 106, page control, and limitations on search size. Once a user has found the user's sought after chat room, a user may join the chat room by using control options 101 or by clicking or otherwise selecting a quick-launch tab 105.

In some aspects, the system may include control options 101 of selecting a specific social network service; selecting a feed distance; selecting a feed topic; or selecting public or private social network service. The system may also include control options 101 defining specifications, accessibility settings, privacy, and mode of communication.

In some aspects, the system may include control options 101 of flagging material for abuse and removal; establishing a search; entering or exiting a virtual space. The system may permit a user to query virtual spaces for established social network services. For example, the method may include querying available chat rooms and viewing the results of the query. Then, the available chat rooms meeting the search criteria may be further sorted, ordered, arranged, and identified by using navigating options 102, chat room order 103, and navigational panels 104. System 100 permits a user to scroll, using scroll bar 106, through available chat rooms or advance pages at a time. In addition, quick-launch tabs 105 may permit numbering, “favoriting,” flagging, or joining the chat room.

In some aspects of this disclosure, the method may include creating a private chat room among certain users or under a certain topic from within or outside of an existing chat room.

In some embodiments of the present invention, the method may include providing navigational panels 104 for the purposes of displaying latest entry, activity, or users in a chat room. The method may also include the social networking services of peer-to-peer sharing (“p2p”), content streaming, content sharing, video chat, collaborative conferencing, blogging, micro-blogging, or match-making.

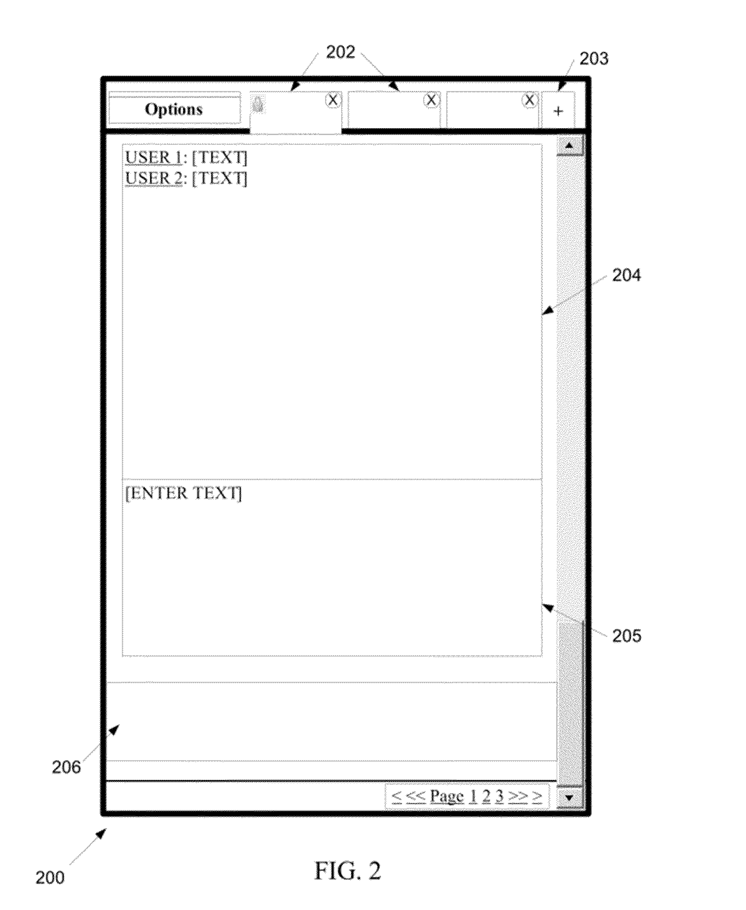

FIG. 2 illustrates a chat room 200 created in a virtual space on a mobile device. Chat room 200 may contain a plurality of select screen tabs 202 indicating, among others, active or inactive chat rooms. The interactive real-time chat display 204 displays the information and data activity in the chat room 200. The active screen provides an information and data input location 205.

In some aspects, the method may allow a plurality of select screen tabs 202 for selecting inactive, favorite, saved, archived, closed, opened, or established chat rooms. Furthermore, select screen tabs 202 may include information or display icons regarding accessibility, topic, time and date, availability, activity, user, or location. In addition, select screen tabs 202 could be modified to allow for, among other things, quick-launch or quick-creation of a chat room 200, using tab modifier 203.

In some aspects, the method may allow a plurality of chat displays 204 and data input locations 205 to be displayed. The system may provide support for partial viewing or layering of chat rooms under the control of select screen tabs 202.

The method may include a plurality of formats for showing data and information in a chat room displays 204. Additionally, the method may allow the chat room 200 or the chat display 204 to be user-definable.

In some aspects, the method may allow a plurality of advertisements 206 that include scrolling or ticking ads, stationary or static ads, flash or html ads, and targeted or general ads. The advertisements 206 may be provided to users by location, topic, popularity, size, distance of the chat room or any other relevant factor.

In some aspects, information in advertisements 206 may be supplied by a person, business, or other entity in or near the geographic area. The entity may have the privilege to provide information because it has supplied the winning bid to advertise to the geographic area.

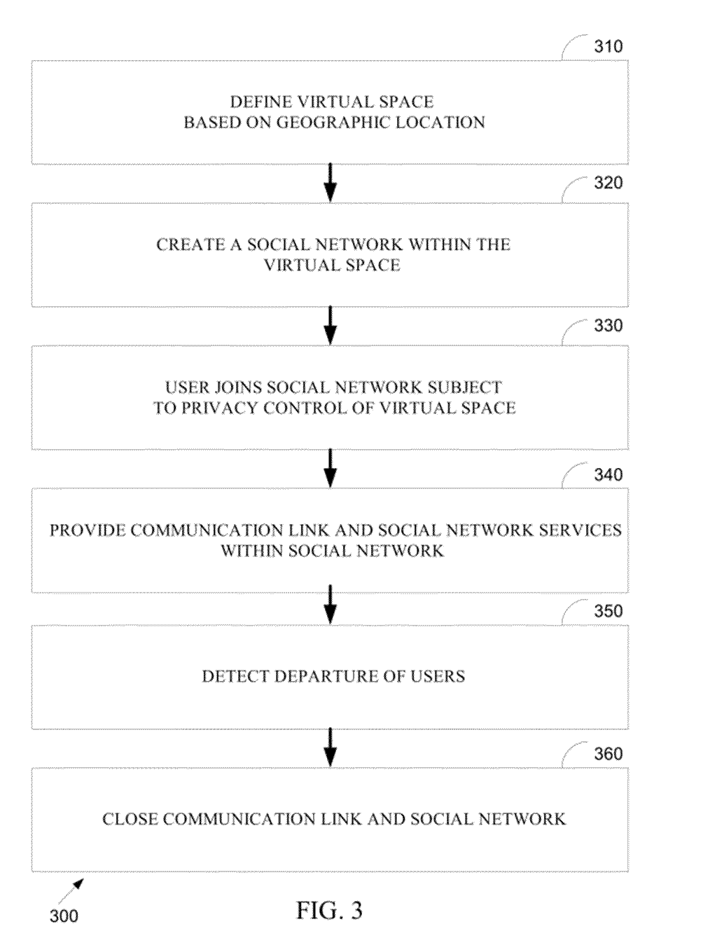

FIG. 3 illustrates a flow chart of a method that may be used to operate chat room 200.

In some embodiments of the present invention, the method may include a user defining a virtual space based on location 310. The virtual space is substantially infinitely user-definable in two- and three-dimensional space. The spatial qualities may be linked to, among others, directories, maps, Global Positioning System coordinates, and gridded-renderings of virtual space.

In some aspects, the method may include creating a social network within the virtual space 320. The creation of the social network may include: establishing searchable parameters; setting accessibility; defining a topic; defining the outermost boundaries; and setting the rules of the social network. Social network services may include chat rooms, peer-to-peer sharing, micro-blogging, blogging, internet accessibility, and streaming content.

The method may also include, creating various accessibility or threshold requirements. The accessibility and threshold requirements may confer permission on users to join or not join an established social network or enter a virtual space 330.

In some aspects, the method may include providing communication links or social network services to users 340.

In some aspects, the method may include detecting the entry or departure of some or all of the users 350. The method may also include detecting the absence of user activity in a virtual space and terminating the space along with clearing any information or data transferred therein.

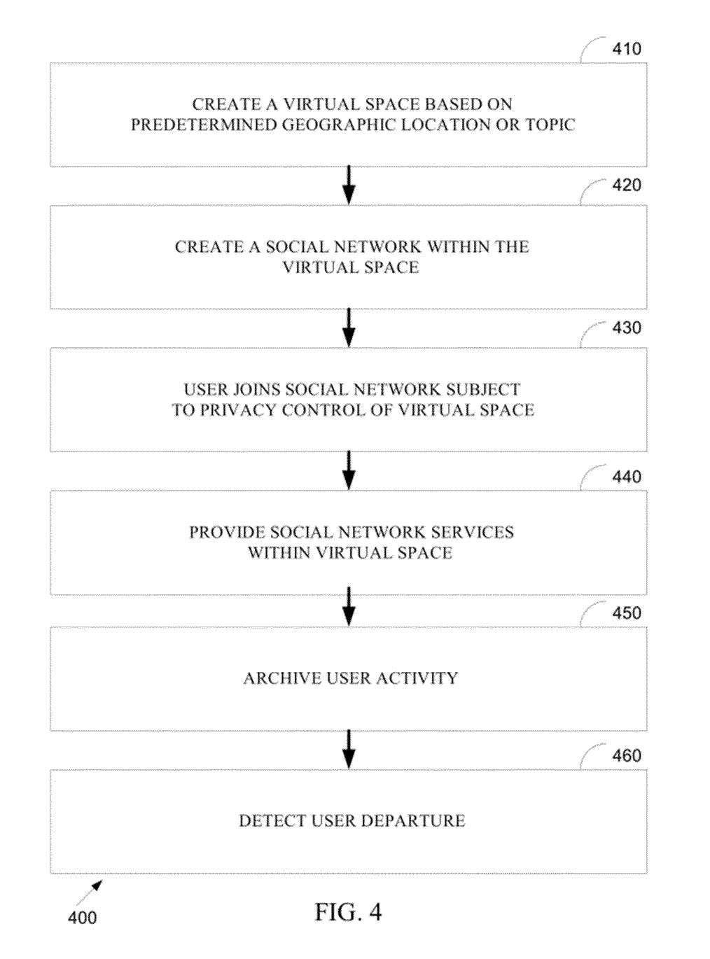

FIG. 4 illustrates a flow chart of a possible method that may be used to operate chat room 200.

In some aspects, the method may include creating a virtual space based on predetermined geographic locations 410. The predetermined geographic locational data may be set by persons with required permissions.

The method may include creating a system based on a topic 410. The topic may be tied to a specific virtual space as well as creating, joining, or enabling social networking services in a predetermined geographic location 420.

In some aspects, the method may include creating, joining, or enabling social networking services by a topic 420. The method may include creating various accessibility or threshold requirements. The accessibility and threshold requirements confer permission on users to join or not join an established social network or enter a virtual space 430.

In some aspects, the method may include joining, viewing as visible to others or viewing as invisible to others 430. The method may also include providing social networking services in the virtual space 440.

In some aspects of this disclosure, the method may include archiving certain user activity and data transfer 450. The data and user activity history may be searchable by certain users and viewable by certain users.

In some aspects, the method may include detecting that all users have departed the virtual space 460. The method may include maintaining the virtual space without any user presence or activity 460.

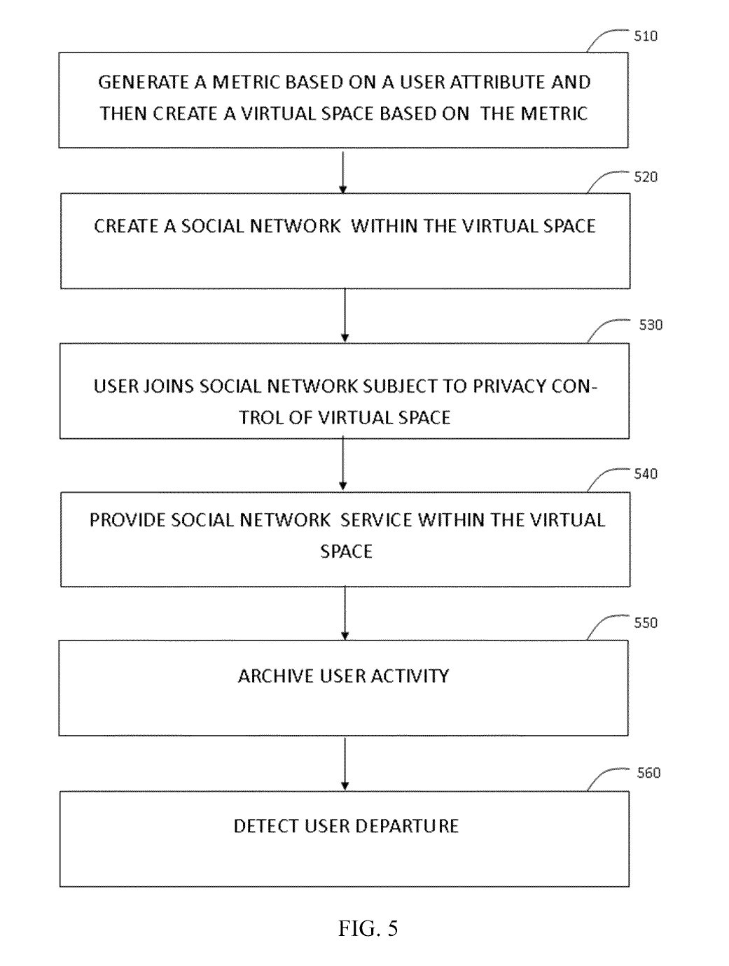

FIG. 5 illustrates a flow chart of a possible method that may be used to operate chat room 200.

In some aspects, the method may include generating a metric based on a user attribute, such as the user's location, profile information, or past activity in the virtual space, and then creating a virtual space 510. The method may include creating, joining, or enabling social networking services within a virtual space 520.

In some aspects, the method may include creating various accessibility or threshold requirements. The accessibility and threshold requirements confer permission on users to join or not join an established social network or enter a virtual space 530.

The method may include joining, viewing as visible to others or viewing as invisible to others 530 as well as providing social networking services in the virtual space 540.

In some aspects, the method may include archiving certain user activity and data transfer 550. The data and user activity history may be searchable by certain users and viewable by certain users and may be used to generate a future metric.

The method may include detecting that all users have departed the virtual space 560 and may include maintaining the virtual space without any user presence or activity 560 or ending the virtual space after all users have departed.

What is claimed is:

1. A method of creating a user defined social network comprising:
defining a geographic area, wherein a user establishes an outermost geographic boundary relative to the user's current location on a map displayed on the user's mobile device;
creating at least one virtual space that facilitates communication among users based on the outermost geographic boundary established by the user; and
establishing a communication link between the user and the at least one virtual space.

2. The method of claim 1 further comprising, a user defining at least one topic of the at least one virtual space.

3. The method of claim 1 further comprising, a user defining at least one searchable parameter of the at least one virtual space.

4. The method of claim 1 further comprising, a user defining accessibility of the at least one virtual space.

5. The method of claim 1 further comprising, detecting user entry and departure of the at least one virtual space.

6. The method of claim 1 further comprising, archiving communication within the at least one virtual space.

7. The method of claim 1 further comprising, detecting departure of all users and terminating access to the at least one virtual space.

8. The method of claim 1 wherein the social network is a chat room.

9. The method of claim 1 further comprising, creating an advertisement space within the at least one virtual space.

10. A method of communicating in a user defined searchable social network comprising:
querying, by a server, available virtual spaces based on a user's geographic location, wherein the user's access to the virtual spaces is determined by previously user defined geographic boundaries;
generating, by the server, a list of available virtual spaces accessible to the user;
selecting at least one virtual space from the list of available virtual spaces;
establishing a communication link between the at least one virtual space and the user.

11. The method of claim 10 further comprising, querying, by the server, available virtual spaces based on a predetermined location.

12. The method of claim 10 further comprising, querying, by the server, available virtual spaces based on topic.

13. The method of claim 10 further comprising, communicating in a chat room within the at least one virtual space.

14. The method of claim 10 further comprising, archiving communications within the at least one virtual space.

15. The method of claim 10 wherein the communication link established provides an accessibility permission to first a user that is different from an accessibility permission provided to a second user.

16. A system that establishes a social network in a virtual space on a mobile device comprising:
a display having an interactive map that is configured to allow a user to define geographic boundaries within which the user is located, the geographic boundaries defining a zone of accessibility, within which one or more users must be located to access the at least one virtual space; and
a user interface configured to allow the one or more users to communicate within the at least one virtual space, wherein the mobile device is configured to communicate wirelessly.

17. The system of claim 16, wherein the at least one virtual space is a chat room.

18. The system of claim 16, wherein a user defines a topic of the at least one virtual space.

19. The system of claim 16, wherein a user defines at least one searchable parameter of the at least one virtual space.

20. The system of claim 16, wherein a user defines accessibility of the at least one virtual space.

21. The system of claim 16, further configured to archive communication within the at least one virtual space.

22. The system of claim 16, wherein the user interface is further configured to detect departure of all users and terminate user access to the at least one virtual space.

23. The system of claim 16, wherein the display is further configured to display advertisement space within the at least one virtual space.

24. A method of assigning a user to a social network comprising:
generating, by a server, at least one metric comprising at least one user attribute;
assigning, by the server, the at least one user to at least one virtual space that facilitates communication among a plurality of users based on the at least one metric; and
establishing a communication link between the at least one virtual space and the at least one user.

25. The method of claim 24 further comprising, creating at least one new virtual space based on the at least one metric.

26. The method of claim 24 further comprising, archiving communication within the at least one virtual space.

27. The method of claim 24, wherein the at least one user attribute comprises a user's location.

28. The method of claim 27, wherein the at least one user attribute further comprises a user's logon information.

29. The method of claim 27, wherein the at least one user attribute further comprises a user's past communication with the social network.

30. The method of claim 24 further comprising, at least one user defining a topic of the at least one virtual space.

31. The method of claim 24 further comprising, at least one user defining at least one searchable parameter of the at least one virtual space.

32. The method of claim 24 further comprising, at least one user defining accessibility of the at least one virtual space.

33. The method of claim 24 further comprising, detecting user entry and departure of the at least one virtual space.

34. The method of claim 24 further comprising, detecting departure of all users and terminating access to the at least one virtual space.

35. The method of claim 24 wherein the social network is a chat room.

36. The method of claim 24 further comprising, creating an advertisement space within the at least one virtual space.
